(19) United States
(12) Patent Application Publication
(10) Pub. No.: US 2015/0339419 A1
(43) Pub. Date: Nov. 26, 2015

(54) EFFICIENT POWER GRID ANALYSIS ON MULTIPLE CPU CORES WITH STATES ELIMINATION

(71) Applicant: Oracle International Corporation, Redwood City, CA (US)

(72) Inventors: Alexander Korobkov, San Jose, CA (US); Subramanian Venkateswaran, Santa Clara, CA (US); Wai Chung William Au, San Jose, CA (US)

(73) Assignee: ORACLE INTERNATIONAL CORPORATION, Redwood City, CA (US)

(21) Appl. No.: 14/285,471

(22) Filed: May 22, 2014

(51) Int. Cl. G06F 17/50

(52) U.S. Cl. CPC G06F 17/5036

(57) ABSTRACT

A method for calculating voltage values in a power grid, including: obtaining a primary circuit representation (PCR) corresponding to the power grid and including: multiple nodes separated by multiple impedances; and an independent source connected to one node; identifying a high degree node; obtaining a modified circuit representation (MCR) by connecting, in the PCR, an auxiliary voltage source having an auxiliary voltage value to the high degree node, the MCR including a modified characteristic matrix and a modified source vector; calculating a modified state vector based on the modified characteristic matrix and the modified source vector; generating an admittance matrix based on the multiple impedances and the auxiliary voltage; obtaining an auxiliary voltage adjustment value using the admittance matrix; obtaining a primary state vector by adjusting the modified state vector using the admittance matrix and the auxiliary voltage adjustment value; and obtaining the voltage values from the primary state vector.

### BACKGROUND

Due to increasing number of transistors on a single semiconductor microchip, on-chip power supply networks have become increasingly complex. Typically, each circuit block requires a certain level of supply voltage at its input. A simulation is often performed to ensure the power supply voltage does not excessively drop between the power supply (e.g., at microchip input pin) and the power lead inputted into the circuit block. This requirement should be ensured for every circuit block on the chip for the entire system to function properly. Unfortunately, power supply networks may include millions of nodes, some of which may have hundreds of thousands of connections to other nodes, resulting in computationally expensive simulations using existing methods.

### SUMMARY

In general, in one aspect, the invention relates to a method for calculating voltage values in a power grid. The method comprises: obtaining a primary circuit representation corresponding to the power grid and comprising: a plurality of nodes separated by a plurality of impedances; and an independent source connected to one node of the plurality of nodes; identifying a high degree node from the plurality of nodes; obtaining a modified circuit representation by connecting, in the primary circuit representation, an auxiliary voltage source having an auxiliary voltage value to the high degree node, wherein the modified circuit representation comprises a modified characteristic matrix and a modified source vector; calculating a modified state vector based on the modified characteristic matrix and the modified source vector; generating an admittance matrix based on the plurality of impedances and the auxiliary voltage; obtaining an auxiliary voltage adjustment value using the admittance matrix; obtaining a primary state vector, wherein obtaining the primary state vector comprises adjusting the modified state vector using the admittance matrix and the auxiliary voltage adjustment value; and obtaining the voltage values from the primary state vector.

In general, in one aspect, the invention relates to a system for calculating voltage values in a power grid. The system comprises: a hardware processor; a matrix generator executing on the hardware processor and configured to: obtain a primary circuit representation corresponding to the power grid and comprising: a plurality of nodes separated by a plurality of impedances; and an independent source connected to one node of the plurality of nodes; identify a high degree node from the plurality of nodes; obtain a modified circuit representation by connecting, in the primary circuit representation, an auxiliary voltage source having an auxiliary voltage value to the high degree node, wherein the modified circuit representation comprises a modified characteristic matrix and a modified source vector; a matrix solver executing on the hardware processor and configured to: calculate a modified state vector based on the modified characteristic matrix and the modified source vector; an admittance module executing on the hardware processor and configured to: generate an admittance matrix based on the plurality of impedances and the auxiliary voltage; obtain an auxiliary voltage adjustment value using the admittance matrix; a voltage adjuster executing on the hardware processor and configured to: obtain a primary state vector, wherein obtaining the voltage vector comprises adjusting the modified voltage vector using the admittance matrix and the auxiliary voltage adjustment value; and obtain the voltage values from the primary voltage vector.

In general, in one aspect, the invention relates to a non-transitory computer readable medium (CRM) storing instructions for calculating voltage values in a power grid. The instructions comprise functionality for obtaining a primary circuit representation corresponding to the power grid and comprising: a plurality of nodes separated by a plurality of impedances; and an independent source connected to one node of the plurality of nodes; identifying a high degree node from the plurality of nodes; obtaining a modified circuit representation by connecting, in the primary circuit representation, an auxiliary voltage source having an auxiliary voltage value to the high degree node, wherein the modified circuit representation comprises a modified characteristic matrix and a modified source vector; calculating a modified state vector based on the modified characteristic matrix and the modified source vector; generating an admittance matrix based on the plurality of impedances and the auxiliary voltage; obtaining an auxiliary voltage adjustment value using the admittance matrix; obtaining a primary state vector, wherein obtaining the primary state vector comprises adjusting the modified state vector using the admittance matrix and the auxiliary voltage adjustment value; and obtaining the voltage values from the primary state vector.

Other aspects of the invention will be apparent from the following description and the appended claims.

### BRIEF DESCRIPTION OF DRAWINGS

FIG. 1 shows a linear circuit block in accordance with one or more embodiments of the invention.

FIG. 2 shows a system in accordance with one or more embodiments of the invention.

FIGS. 3A, 3B, 4A, and 4B show matrix equations in accordance with one or more embodiments of the invention.

FIG. 5 shows a flowchart in accordance with one or more embodiments of the invention.

FIG. 6 shows an example in accordance with one or more embodiments of the invention.

FIG. 7 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and a system for simulating voltage values in a linear circuit representing a power grid. More specifically, embodiments of the invention are directed towards reducing the complexity of matrix factorization and other computation steps required for calculating the voltage values by first removing high degree nodes (i.e., nodes with a lot of connections to other nodes). The calculations can be performed on a simpler, modified circuit to yield an estimated result. Subsequently, several corrections are performed to adjust the estimated result so that it is accurate for the original circuit. This process may require less computational resources than directly solving the unmodified power grid.

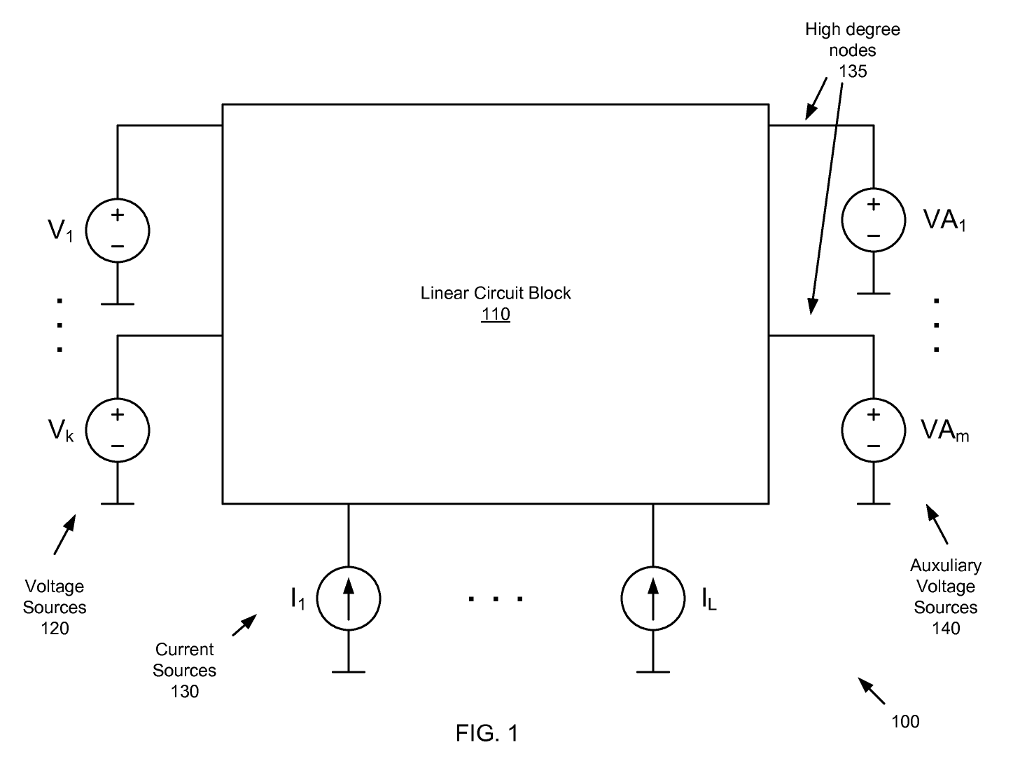

FIG. 1 shows a power grid (100) in accordance with one or more embodiments of the invention. FIG. 1 includes a series of voltage sources (120) and current sources (130) connected to input nodes of a linear circuit block (110). Further, the linear circuit block (110) may contain high degree nodes (135) to which auxiliary voltage sources (140) may be connected. The power grid (100) is an electrical circuit representation of the physical design layout (e.g., a series of equations, matrices, text files, schematics, layouts, or any other human and/or computer readable medium representing a power grid).

In one or more embodiments of the invention, the linear circuit block (110) is physical circuit (e.g., circuit components connected with wires) or a representation of a circuit that forms the core of a power grid of a physical device (e.g., a microchip). The linear circuit block (110) may contain linear electrical components (e.g., resistors, capacitors, inductors) and connections between the components (e.g., conductive wires). The linear circuit block (110) modeling a microchip may contain thousands to millions of impedances and/or connections between impedances. In one or more embodiments of the invention, the linear circuit block (110) is a resistor network, where each resistor models the resistance of a conductive material (e.g., copper or aluminum metal layers in a microchip) used to deliver current to circuit module (e.g., a logic block). Those skilled in the art will appreciate that power grids may be accurately modeled by resistor networks even though physical power grids might not have distinct nodes and resistors. In one or more embodiments of the invention, the power grid contains frequency and time dependent impedances (e.g., inductors or capacitors) to facilitate the modeling of time-dependent effects (e.g., current bursts or voltage spikes).

In one or more embodiments of the invention, the high degree nodes (135) are nodes in the linear circuit block (110) that have substantially more connections to other nodes in the linear circuit block (110) than the average node in the linear circuit block (110). Those skilled in the art, having the benefit of this detailed description, will appreciate that power grids often have nodes that have order of magnitudes more connections than a typical node their layout. For example, if a typical node has 10 connections, a node may be considered a high degree node if it has 100-1000 or more connections. In one or more embodiments of the invention, a high degree node has on the order of 100,000-1,000,000 connections. Those skilled in the art will appreciate that nodes with this many connections may substantially slow down circuit simulators and/or circuit solvers when simulating/solving a power grid. In one or more embodiments of the invention, high degree node (135) may also be identified by circuit computation performance and any other heuristics known to those skilled in the art. For example, a node may be considered a high degree node if removing it in accordance with one or more embodiments of this invention yields to a faster computation performance. While this may involve a simulation overhead, often times simulations need to be repeated many times (e.g., for multiple time steps in a time-dependent simulation), and once a node is identified as reducing simulation performance in the first simulation it may be considered a high degree node in subsequent simulations.

In one or more embodiments of the invention, the voltage sources (120) are physical voltage sources (e.g., power supplies) or representations of physical voltage sources that are connected to input nodes of a power grid. The voltage sources (120) provide a constant voltage potential to the nodes of the linear circuit block (110) that they are connected to. In one or more embodiments of the invention, the voltage sources (120) represent the constant potential at the pads of a microchip or at the output of on-chip voltage regulators, transformers, and/or input/output (I/O) circuits which are connected to the power grid. The constant potential may be maintained by a connection to a local on-board regulator, power supply, and/or battery.

In one or more embodiments of the invention, the current sources (130) are physical current sources (e.g., current mirrors) or representations of current sources. The current sources (130) conduct a constant current into the nodes of the linear circuit block (110) that they are connected to. In one or more embodiments of the invention, the current sources (130) represent circuit blocks (e.g., current mirrors, digital blocks, analog circuit blocks) that consume current. Those skilled in the art will appreciate that most circuit blocks consume current rather than generate current, so that the current values I₁ through I_{L} may be negative.

In one or more embodiments of the invention, the auxiliary voltage sources (140) are virtual voltage sources connected to high degree nodes (135). Auxiliary voltage sources (140) might not represent actual physical voltage sources in the power grid; rather they may be added into the circuit representation of the power grid in order to effectively remove the high degree (135) nodes from the circuit representation (e.g., by simplifying circuit matrix equations, discussed further below). Those skilled in the art will appreciate that adding a known voltage source to a circuit generally facilitates the computation of other unknown voltages in that circuit.

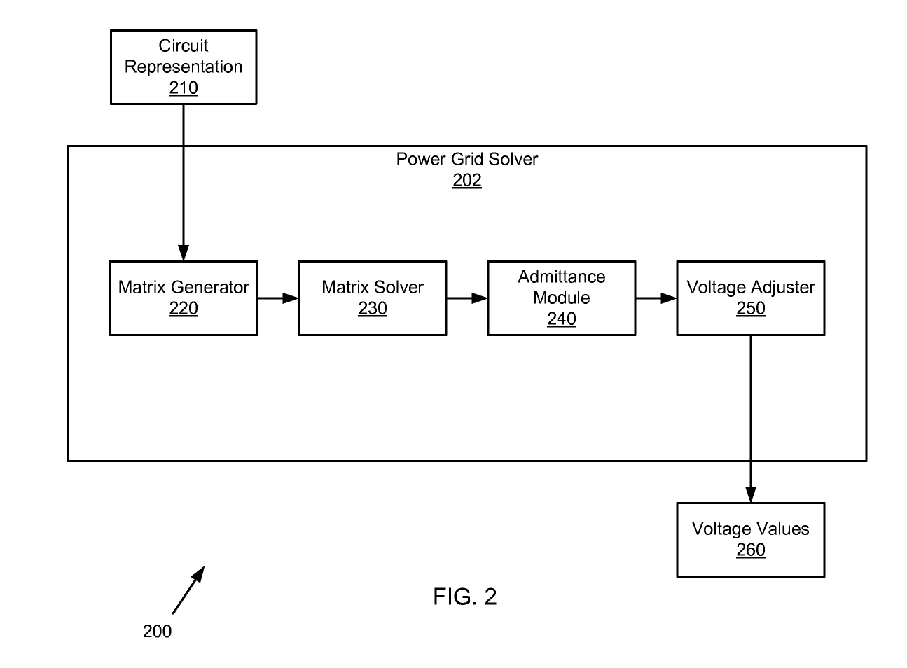

FIG. 2 shows a system (200) in accordance with one or more embodiments of the invention. The system (200) includes a power grid solver (202) that takes a circuit representation (210) as input and outputs voltage values (260) for nodes within the circuit representation (210). The power grid solver (202) includes a matrix generator (220), a matrix solver (230), an admittance module (240), and a voltage adjuster (250). The power grid solver (202) may be purely a software system executing on a hardware processor or may contain dedicated hardware (e.g., application specific integrated circuits (ASICs) for matrix multiplication/manipulation). Details regarding the individual components of the system (200) are further discussed below.

In one or more embodiments of the invention, a circuit representation (210) is a textual, visual, schematic, physical, mathematical, matrix, and/or computer readable representation of a circuit (e.g., a power grid) to be simulated or solved. The circuit representation (210) may be the same or similar to the power grid (FIG. 1, 100) but without auxiliary voltage sources (FIG. 1, 140). In one or more embodiments of the invention, the circuit representation (210) has internal nodes that have an unknown voltage levels that are to be computed given initial stimuli. The stimuli may be voltage sources (e.g., FIG. 1, 120) and current sources (e.g., FIG. 1, 130) that are part of the circuit representation (210). In one or more embodiments of the invention, the circuit representation (210) may be a matrix equation (e.g., an equation including an impedance matrix, a conductance matrix, a vector of circuit states, a vector representing independent voltage and current sources, or a combination of the aforementioned matrices).

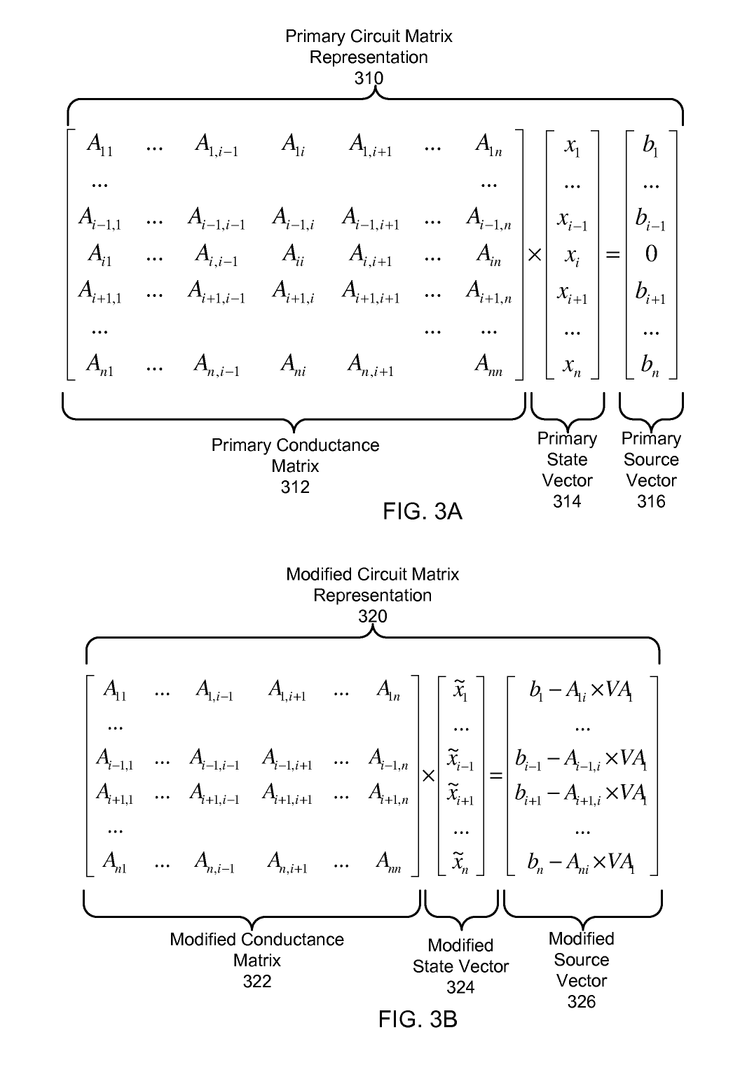

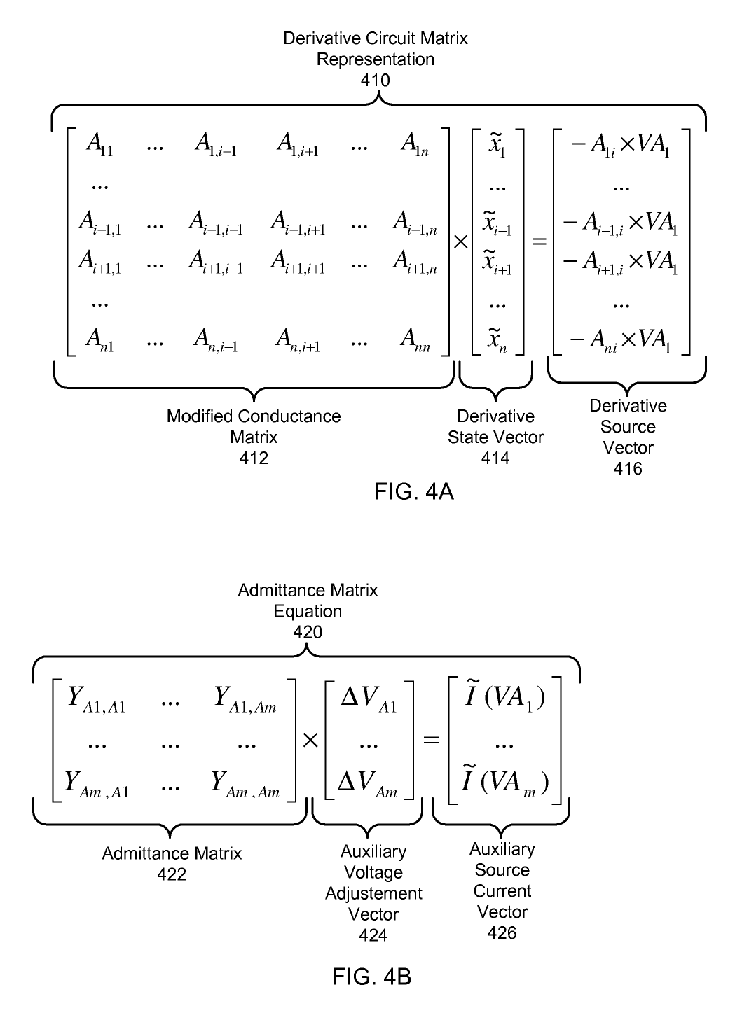

In one or more embodiments of the invention, the matrix generator (220) is a hardware module (e.g., ASIC) or a software module (e.g., a software program executing on a hardware processor) used to convert a circuit representation into a matrix equation to be solved. Those skilled in the art will appreciate that a linear circuit may be represented by the equation Ax=b, where A is a matrix of corresponding to impedances between nodes of a circuit, x is a vector corresponding to circuit states (e.g., node voltages or loop currents) and may be initially unknown, and b is a vector representing circuit stimuli (e.g., voltage and current sources). The matrix generator (220) may convert the circuit representation (210) into one of the matrices shown in FIGS. 3A, 3B, and 4A, discussed further below. In one or more embodiments of the invention, the matrix generator (220) identifies the high degree nodes in a circuit representation (210). Those skilled in the art will appreciate that finding high degree nodes in a matrix representation of a circuit may be performed by finding the rows and columns in matrix A that have few ‘0’ entries or have more non-‘0’ entries than a threshold. In the case the circuit representation (210) is already in matrix form, the matrix generator (220) may convert the circuit representation (210) to another form (e.g., from a matrix of FIG. 3A to the one in FIG. 3B) depending on high degree nodes that were identified.

In one or more embodiments of the invention, the matrix solver (230) is a hardware module (e.g., ASIC) or a software module (e.g., a software program executing on a hardware processor) used to solve the matrix equations generated by the matric generator (220). Those skilled in the art will appreciate that a variety of algorithms for solving matrix equations exists, for example using matrix factorization (e.g., LU decomposition, Cholesky decomposition, QR decomposition, etc.) and backwards/forward substitution. The matrix solver (230) may solve the value of the x vector in the matrix equation described above.

In one or more embodiments of the invention, the admittance module (240) is a hardware module (e.g., ASIC) or a software module (e.g., a software program executing on a hardware processor) used to generate an admittance matrix capable of correcting the voltage values of the auxiliary voltage sources. Those skilled in the art will appreciate that the solution from the matrix solver might not be the correct solution for the circuit representation (210) because auxiliary voltage sources (FIG. 1, 140) were added to the power grid. Further, the auxiliary voltage sources are likely to have voltage values different than the high degree nodes would have had if the auxiliary voltage sources were not added. Consequently, the admittance module (240) is needed to calculate admittances between nodes that are used to correct the auxiliary voltage sources. In one or more embodiments of the invention, the admittance module (240) generates an admittance matrix that is used to calculate the self-admittance of the high degree nodes and the admittance between each pair of high degree nodes.

In one or more embodiments of the invention, the voltage adjuster (250) is a hardware module (e.g., ASIC) or a software module (e.g., a software program executing on a hardware processor) used to adjust the result from the matrix solver (230) and the admittance module (240). The voltage adjuster (250) may first correct the auxiliary voltage values based on the admittance matrix generated by the admittance module (240). The voltage adjuster (250) may also use the corrected auxiliary voltage values to adjust the node voltages of the circuit representation (210) calculated with the uncorrected auxiliary voltage sources by the matrix solver (230).

In one or more embodiments of the invention, the voltage values (260) are calculated values of voltages in the nodes of the power grid. The nodes of interest may be some or all nodes of the power grid that are not known before the calculation (i.e., do not have a voltage source attached to them). The voltage values (260) may be used to verify that they are within bounds for the circuit blocks they are used to power. The voltage values (260) may be static, time-dependent, frequency dependent, temperature dependent, stress dependent, and in general may vary with any parameter that may change the impedances of the power grid or the values of the voltage sources and/or current sources.

FIG. 3A shows a primary circuit representation (310) that mathematically represents a power grid (e.g., FIG. 1, 100) or any other linear circuit. The primary circuit representation (310) may be a matrix equation and may include a primary conductance matrix (312), a primary state vector (314), and a primary source vector (316). Those skilled in the art will appreciate that other methods of representing a linear circuit exist (e.g., series of equations, an impedance matrix instead of a conductance matrix). Although the rest of the application may focus on a matrix circuit representation using a conductance matrix as shown in FIG. 3A, the present invention shall not be limited to only this version.

In one or more embodiments of the invention, the primary conductance matrix (312) includes a series of conductance values corresponding to nodes in the power grid and is organized into a square matrix. For example, A₁₁ represents the conductance of node 1 to every other node (as if every other node was at ground) including the conductance of node 1 to ground whereas A₁₂ represents the conductance from node 1 to node 2. Those skilled in the art will appreciate that an impedance network with n unknown nodes may be represented by a primary conductance matrix (312) of size n×n. The conductance within the primary conductance matrix (312) may be real, complex, and/or time or frequency dependent, although power grid analysis is often performed with real conductance (e.g., only using resistors in the primary circuit representation).

In one or more embodiments of the invention, the primary state vector (314) is a vector of circuit states. Circuit states may be voltages at the nodes of a power grid or loop currents at loops of a power grid, depending how the matrix equation is written (e.g., if a conductance matrix is used, the vector may include values in units of voltage, whereas if an impedance matrix is used, the primary state vector (314) may include values with units of amps). The primary state vector (314) includes the unknown values that are being solved; solving a power grid or other linear circuits in accordance to one or more embodiments of this invention involves calculating the values in the primary state vector that enforces the matrix equation of FIG. 3A.

In one or more embodiments of the invention, the primary source vector (316) is a vector of independent source values of independent sources (e.g., voltage sources (FIG. 1, 120) or current sources (FIG. 1, 130)) neighboring the unknown nodes. Each primary source vector value may be calculated for each node by finding the current entering or exiting a node due to a connected independent current source or a neighboring voltage source (in the case of the latter, the current may be calculated by the voltage of the independent voltage source divided by the resistance of the resistor separating the independent voltage source from the node in question).

Those skilled in the art will appreciate that conductance values multiplied by unknown voltage states yield units of current, so the units of the equation are consistent with Ohm's law. Further, those skilled in the art will appreciate that the conductance matrix representation may be derived using Kirchhoff's current law (KCL) and that an impedance matrix representation may be derived using Kirchhoff's voltage law (KVL).

FIG. 3B shows a modified circuit representation (320), which is the same as the primary circuit representation (310) but with some states (e.g., states associated with high degree nodes) removed, in accordance with one or more embodiments of the invention. For example, consider that state associated with node i from the primary circuit representation (310) is to be removed (e.g., the node is a high degree node and an auxiliary voltage source (V_{A1}) is attached to it, making the node state or voltage a known value). To properly modify the equation, one may remove xᵢ from the primary state vector (314) to arrive with the modified state vector (324). Further, one may remove the row and column associated with node i from the primary conductance matrix (312) to arrive at the modified conductance matrix (322). Lastly, one may adjust the primary source vector (316) by removing the entry associated with node i and subtracting Aₓᵢ×V_{A1} from each entry associated with node x to arrive at the modified source vector (326). Those skilled in the art will appreciate that the modifications made in the modified circuit representation (320) are physically consistent with the same circuit as the one represented in the primary circuit representation (310) but with an auxiliary voltage (V_{A1}) added and connected to node i. The values of the modified state vector (324), when solved, may be different than those of the primary state vector (314) since the circuit is effectively changed, hence different symbols are used to identify the values in the respective state vectors. Those skilled in the art, having the benefit of this detailed description, will appreciate that the modified conductance matrix (322) is smaller (or less dense when the row and column are kept and set to 0) than the primary conductance matrix (312) and thus may be simpler to factorize. The steps presented above to arrive at the modified circuit representation (320) may be repeated for other nodes (e.g., other high degree nodes) to reduce the size of the modified conductance matrix (322) further. Once the modified conductance matrix (322) is reduced to an acceptable level (e.g., all states associated with high degree nodes are effectively removed), the equation of FIG. 3B may be solved, for example using matrix factorization and substitution steps.

FIG. 4A shows a derivative circuit matrix equation (410), which is the same as the modified circuit matrix representation (320) except independent sources are turned off (i.e., independent voltages are set to zero volts (i.e., shorted) and independent current sources are set to zero amps (i.e., opened)), in accordance with one or more embodiments of the invention. With the independent sources turned off, all values of b in the derivative source vector (416) become 0 A. The derivative state vector (414) may be used for calculating additional current the auxiliary voltages provide, which may help in correcting the modified state vector (324) to obtain the primary state vector (314) and thus solve the original circuit. Those skilled in the art will appreciate that since the derivate conductance matrix (412) is the same as the modified conductance matrix (422), any matrix factorization steps applied to the modified conductance matrix (422) do not have to be repeated. Further, solving the matrix equation in FIG. 4A, given a factorized derivate conductance matrix (422), may be computationally inexpensive relative to factoring the modified conductance matrix (422).

FIG. 4B shows an admittance matrix equation (420) used to correct the voltage values of the auxiliary voltage sources, in accordance with one or more embodiments of the invention. The admittance matrix (422) is a matrix showing the self-admittance values of nodes (e.g., Y_{A1,A1}) or trans-admittance values of nodes (e.g., Y_{A1,A2}). Those skilled in the art will appreciate that an admittance matrix (422) may be derived in many ways, for example, by using two measurement points for each high degree node, or by exploiting current locality effects. In one or more embodiments of the invention, the auxiliary voltage adjustment vector (424) is a vector of auxiliary voltage adjustments that are the difference between the auxiliary voltage values and the actual values in the primary circuit representation (310) if it were solved for directly. Naturally, the auxiliary voltage adjustments are needed to correct the auxiliary voltages since the goal is to solve the primary circuit representation (310). In one or more embodiments of the invention, the auxiliary source current vector (426) is a vector of currents from the auxiliary voltage sources, which is calculated from a modified circuit representation (320).

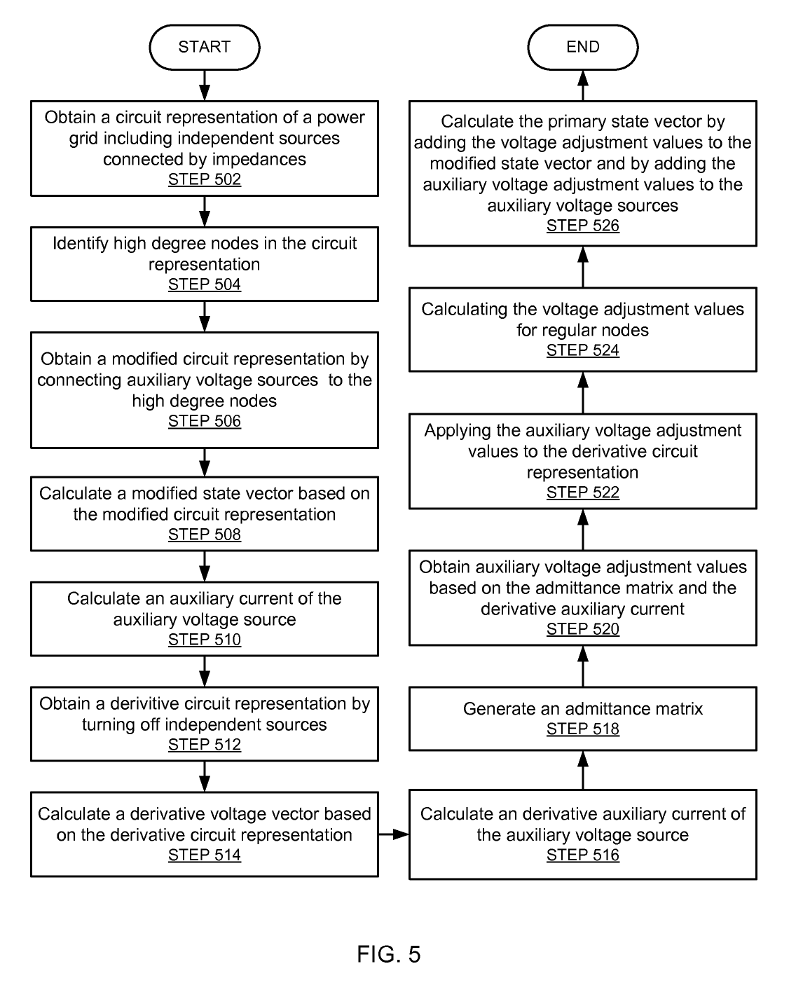

FIG. 5 shows a flowchart for calculating voltage values from a circuit representation of a power grid. The process shown in FIG. 5 may be executed, for example, by one or more modules as discussed above in reference to FIG. 2 and may include matrix computations as those discussed in reference to FIGS. 3A, 3B, 4A, and 4B. One or more steps shown in FIG. 5 may be omitted, repeated, and/or performed in a different order among different embodiments of the invention. Accordingly, embodiments of the invention should not be considered limited to the specific number and arrangement of steps shown in FIG. 5.

Initially, a primary circuit representation of a power grid is obtained (Step 502). As discussed above, the primary circuit representation may be the same or similar to that references in FIG. 1, but without auxiliary voltage sources (e.g., FIG. 1, 140). The primary circuit representation may include a linear circuit block (e.g., FIG. 1, 110) that is an impedance network (e.g., a network of interconnected resistances). The primary circuit representation may be obtained by human input (e.g., drawing a schematic, inputting text to form a netlist) or be generated from an existing schematic, layout, netlist, matrix equation, and any other computer readable source.

In Step 504, high degree nodes are identified from the primary circuit representation. As discussed above, high degree nodes may be nodes that have a number of connections to other nodes above a threshold. The threshold may be a fixed number or may be based on a heuristic, such as a multiplier over of the mean or median of the number of connections of all nodes in the primary circuit representation. In another embodiment of the invention, high degree nodes are identified using a feedback mechanism (e.g., a circuit simulation is performed with and without a node removed, and if the simulation time improves when the node is removed, that node is labeled a high degree node for subsequent simulations). In one or more embodiments of the invention, the primary circuit representation may be in matrix form or may be converted to matrix form; the high degree nodes may then be obtained by counting the number of non-zero entries on the rows or columns of a conductance matrix.

In Step 506, a modified circuit representation is obtained from the primary circuit representation. The modified circuit representation may be a matrix equation representation (e.g., FIG. 3B) of the power grid, including a modified conductance matrix, a modified state vector, and a modified source vector. The modified circuit representation is obtained by adding auxiliary voltage sources to high degree nodes and modifying the primary circuit representation accordingly, as described above in reference to FIG. 3B. The values of the auxiliary voltage sources may be arbitrarily chosen but are generally selected between the negative and positive supply voltages (e.g., if the negative supply is −1V and the positive supply is 1V, an auxiliary voltage values may be 0.75V). The values of the auxiliary voltage sources may be all equal to a single value (e.g., midpoint between supply rails) or may be set to different values.

In Step 508, the modified voltage vector in the modified circuit representation is calculated. As described above, the calculation may involve factorizing the modified conductance matrix and performing backwards/forward substitution steps to obtain all unknown values of the modified state vector.

In Step 510, the auxiliary currents of the auxiliary voltage are calculated. The auxiliary current is the current that the auxiliary voltage sources generate. Those skilled in the art will appreciate that the auxiliary current is generally non-zero as the voltage values of the auxiliary voltage sources do not match what they would be if the primary state vector were solved for the high degree nodes. Those skilled in the art will appreciate that auxiliary currents may be readily found by applying Ohm's law to the solved modified state vector and the auxiliary voltages. For example, if an auxiliary source has a voltage value of 2V and is only connected to one other node of voltage 1V over a resistance of 1Ω, then the auxiliary current can be found by taking 2V−1V/1Ω=1 A.

In Step 512, a derivative circuit representation is obtained. The derivative circuit representation may be a matrix equation representation (e.g., FIG. 4A) of the power grid, including a derivative conductance matrix, a derivative state vector, and a derivative source vector. In one or more embodiments of the invention, the derivative circuit representation is obtained from the modified circuit representation by turning off the independent sources of the modified circuit representation. Consequently, the derivative source vector may be the same as the modified source vector but with the values of the independent sources set to zero. In one or more embodiments of the invention, the derivative conductance matrix is the same as the modified conductance matrix; consequently any matrix factorization steps performed on the modified conductance matrix in Step 510 might not have to be repeated. Those skilled in the art will appreciate that the derivative circuit representation may be obtained prior to Step 510 (i.e., before solving the modified matrix representation).

In Step 514, the derivative state vector in the derivative circuit representation is calculated. Similar to Step 510, the calculation may involve performing backwards/forward substitution steps to obtain all unknown values of the derivative state vector.

In Step 516, the derivative auxiliary currents of the auxiliary voltage are calculated. Similarly to Step 512, the derivative auxiliary current is the current that the auxiliary voltage sources generate in the derivative circuit representation (i.e., when independent sources are turned off).

In Step 518, an admittance matrix is generated using the derivative circuit representation and the derivative auxiliary current. In the case of a single auxiliary voltage source, the admittance value (i.e., an admittance matrix of size 1×1) may be calculated by dividing the derivative auxiliary source current by the auxiliary source voltage. In the case that there are more than one auxiliary voltage sources, and admittance matrix of dimensions m×m i generated, where m is the number of auxiliary voltage sources. In this case, the admittance matrix includes both the self admittance of each high degree node and the trans-admittance between any pair of two high degree nodes. This can be found, for example, by using two measurement points at two different voltage values (e.g., 0V and the supply voltage) for each high degree node. Another way to calculate the admittance values is to first calculate, for each pair of nodes (if), the trans-admittance using equation:

$${Y}_{ij} = \frac{\hat{I} ( {V}_{j} )}{{V}_{i}}$$

which is the contribution of Vᵢ into the current of Vⱼ. Then the self admittance may be calculated, for example, by

$${Y}_{ii} = \hat{I} ( {V}_{i} ) - {\sum }_{j = 1 , j \neq i}^{m} {Y}_{ij} \times \frac{{V}_{j}}{{V}_{i}}$$

Where Î(Vᵢ) is the derivative auxiliary current from auxiliary source i, Yᵢⱼ is the trans-admittance from node i to node j, and Vᵢ and Vⱼ are the values of the auxiliary sources attached to nodes i and j, respectively. Those skilled in the art will appreciate that deriving the admittance matrix has a computational complexity proportional to m (i.e., the number of high degree nodes), and that as long as the number of high degree nodes is much smaller than the number of total nodes, this operation is substantially less complex than directly solving for the primary state vector in the primary circuit representation. Further, those skilled in the art will appreciate that the admittance matrix has to only be generated once, and that if the primary circuit representation is re-simulated with different stimuli (i.e., different values of independent source voltages, for example for different simulation time steps) then the admittance matrix may be reused. This is especially useful since in most practical situations (e.g., clock changing for digital logic) the values of independent sources change frequently, whereas the values of the power grid resistor network (e.g., due to temperature changes) do not.

In Step 520, the auxiliary voltage adjustment values are calculated from the admittance matrix and the auxiliary source current. Intuitively, a non-zero auxiliary source current means that the auxiliary source voltage is different than it would be if solved in the primary circuit representation, since if it were the same then no current would flow through it. Consequently, given a linear circuit, the auxiliary voltage adjustment should be the auxiliary voltage current divided by the self-admittance of that high degree node, given by

$${\tilde{V}}_{A 1} = {V}_{A 1} - {χ}_{i} = \frac{I ( {\tilde{V}}_{A 1} )}{{Y}_{ii}}$$

In the case there are multiple high degree nodes, the matrix equation using the admittance matrix (e.g., FIG. 4B) may be used to calculate the auxiliary voltage adjustments for all high degree nodes at once.

In Step 522, the auxiliary voltage adjustment values (e.g., \tilde{V}_{A1} through \tilde{V}_{Am} as in FIG. 4B) are reapplied to the derivative circuit representation in place of the auxiliary voltage values (e.g., V_{A1} through V_{Am} as in FIG. 1). Those skilled in the art will appreciate that due to the linear nature of the power grid circuit, reapplying auxiliary voltage adjustment values to the derivate circuit representation and solving for the derivative source vector yields voltage adjustment values for all other unknown nodes (i.e., nodes that are to be solved that were not identified as high degree nodes).

In Step 524, the adjustment state values for regular nodes (i.e., unknown nodes to be solved that are not high degree nodes) are calculated from the derivative matrix representation with the auxiliary voltage adjustment values reapplied, as described in Step 522. Matrix factorization may not be necessary in this step since the derivative characteristic matrix is the same as the modified characteristic matrix and may have been factorized in Step 508.

In Step 526, the primary state vector is obtained. This is performed by adding the auxiliary voltage adjustment values obtained in Step 520 to the auxiliary voltages and by adding the adjustment voltage values obtained in Step 524 for the regular nodes to the modified state vector calculated in Step 508. In other words, one corrects the auxiliary voltages selected in Step 506 and the calculated modified state vector in Step 508 which is inevitably incorrect due to the addition of the auxiliary voltages. Those skilled in the art, having the benefit of this detailed description, will appreciate that the corrected auxiliary voltage values may be calculated earlier (e.g., after Step 520 where the auxiliary voltage adjustment values are calculated).

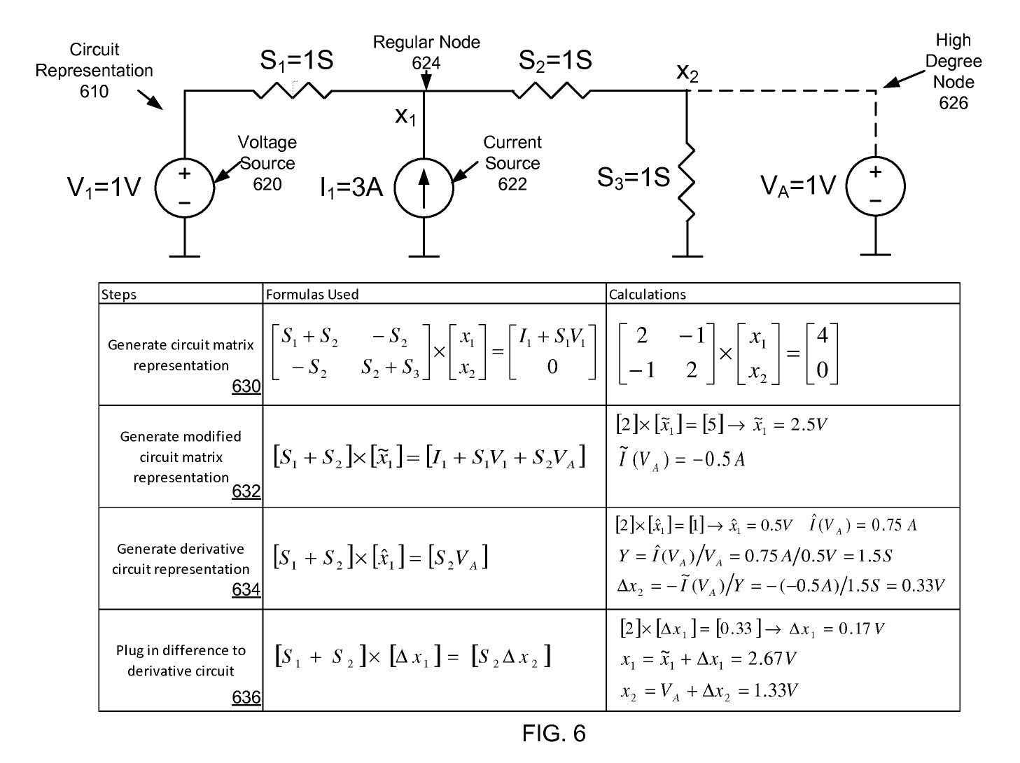

FIG. 6 shows an example for calculating voltage values from a circuit representation of a power grid. The process shown in FIG. 6 may be executed, for example, by one or more modules as discussed above in reference to FIG. 2, may include matrix computations as those discussed in reference to FIGS. 3A, 3B, 4A, and 4B, and may follow the steps presented in reference to FIG. 5. Those skilled in the art will appreciate that FIG. 6 shows only an example of a calculation in one or more of the embodiments of the invention and will not be used to constrain any part of the present invention.

In one or more embodiments of the invention, FIG. 6 includes an example circuit representation (610) that includes a voltage source (620), a current source (622), and three resistors denoted by their conductance values S₁, S₂, and S₃. There exist two unknown nodes, x₁ and x₂, in the circuit representation (610). A primary circuit matrix representation of this circuit may be written (630). Those skilled in the art will appreciate that in this form the cross conductance values are negative and the self-conductance values are positive, and that the equation would still hold true the values in the primary conductance matrix and the primary source vector were inversed.

In order to solve for the voltage values of the unknown nodes, node x₂ is identified as a high degree node (626) and an auxiliary voltage source (V_{A}) is added to it. The value of the auxiliary voltage vector is chosen to be 1V, the same as that of the independent voltage source (620). Node x₁ is identified as a regular node (624). Those skilled in the art will appreciate that the circuit representation (610) is computationally simple to solve and does not necessitate the use of the method presented in FIG. 5 to solve, however for the sake of example a simple circuit is chosen for demonstration. Further, those skilled in the art will appreciate that node x₂ is arbitrarily chosen as a high degree node, even though its number of connections is only two, which is the same as that of node x₁.

Once the auxiliary voltage source is added, a modified circuit representation can be obtained (632). The modified circuit representation can be readily solved to obtain a value for the regular node (624), \tilde{χ}₁=2.5V. As discussed above, this value is likely not the same as value of x₁ in the unmodified circuit representation as it is unlikely the auxiliary voltage source that was added was the same as the unsolved value of x₂. Finally the current through the auxiliary voltage source, can be calculated and Ĩ(V_{A})=−0.5 A.

In (634), the derivate matrix representation is obtained by setting V₁=0V and I₁=0 A. The matrix equation can be readily solved for the regular node (624), yielding \hat{χ}₁=0.5V. The derivative auxiliary current through the auxiliary voltage source in the derivative circuit can be readily found and Î(V_{A})=0.75 A.

At this point an admittance matrix may be generated, but for this example since there exists only one high degree node, a single admittance is calculated by dividing the derivative auxiliary current by the auxiliary voltage source voltage to obtain Y=1.5 S. The auxiliary voltage adjustment value can now be calculated and is ΔV_{A}=0.33V, leading to a corrected auxiliary voltage of x₂=1V+0.33V=1.33V.

Finally, the node voltage of the regular node needs to be adjusted. This is performed by substituting the auxiliary voltage adjustment value, ΔV_{A}=0.33V, for the auxiliary voltage value, V_{A}=1V, in the derivative circuit representation, and solving for x₁, to obtain Δx₁=0.17V. Finally this value is added to the value of node the regular node (624) calculated in χ₁=χ₁+Δχ₁=2.5V+0.17V=2.67V. Those skilled in the art will appreciate that this is the correct value of x₁ given the circuit representation (610).

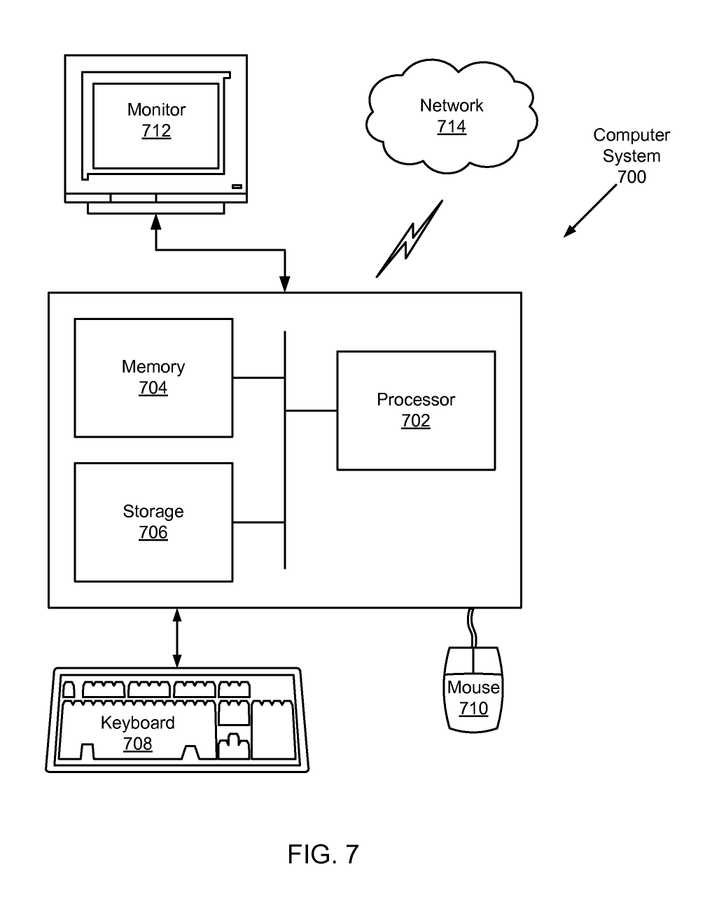

Embodiments of the invention may be implemented on virtually any type of computer regardless of the platform being used. For example, as shown in FIG. 7, a computer system (700) includes one or more processors (702), associated memory (704) (e.g., random access memory (RAM), cache memory, flash memory, etc.), a storage device (706) (e.g., a hard disk, an optical drive such as a compact disc (CD) drive or digital video disk (DVD) drive, a flash memory stick, etc.), and numerous other elements and functionalities typical of today's computers (not shown). The computer (700) may also include input means, such as a keyboard (708), a mouse (710), or a microphone (not shown). Further, the computer (700) may include output means, such as a monitor (712) (e.g., a liquid crystal display (LCD), a plasma display, or cathode ray tube (CRT) monitor). The computer system (700) may be connected to a network (714) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (700) includes at least the minimal processing, input, and/or output means necessary to practice embodiments of the invention.

Further, those skilled in the art will appreciate that one or more elements of the aforementioned computer system (700) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a digital video disc (DVD), flash memory stick, a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for calculating voltage values in a power grid, comprising:
obtaining a primary circuit representation corresponding to the power grid and comprising:
a plurality of nodes separated by a plurality of impedances; and
an independent source connected to one node of the plurality of nodes;
identifying a high degree node from the plurality of nodes;
obtaining a modified circuit representation by connecting, in the primary circuit representation, an auxiliary voltage source having an auxiliary voltage value to the high degree node, wherein the modified circuit representation comprises a modified characteristic matrix and a modified source vector;
calculating a modified state vector based on the modified characteristic matrix and the modified source vector;
generating an admittance matrix based on the plurality of impedances and the auxiliary voltage;
obtaining an auxiliary voltage adjustment value using the admittance matrix;
obtaining a primary state vector, wherein obtaining the primary state vector comprises adjusting the modified state vector using the admittance matrix and the auxiliary voltage adjustment value; and
obtaining the voltage values from the primary state vector.

2. The method of claim 1, wherein the high degree node has a number of connections greater than a threshold.

3. The method of claim 1, wherein the modified matrix comprises impedance values associated with the plurality of impedances, and wherein the modified source vector corresponds to the plurality of nodes and the independent source.

4. The method of claim 1, further comprising:
calculating an auxiliary current of the auxiliary voltage source from the modified state vector, wherein the auxiliary voltage adjustment value is further based on the auxiliary current.

5. The method of claim 1, further comprising:
calculating a derivative auxiliary current of the auxiliary voltage source from a derivative state vector, wherein the admittance matrix is further based on the derivative auxiliary current.

6. The method of claim 1, wherein the modified characteristic matrix is a conductance matrix.

7. The method of claim 1, wherein calculating the modified state vector comprises:
obtaining a plurality of factored matrices by factoring the modified characteristic matrix; and
performing a forward substitution and a backward substitution on the plurality of factored matrices.

8. The method of claim 5, wherein generating the admittance matrix comprises:
obtaining a derivative circuit representation by turning off, in the modified circuit representation, the independent source, wherein the derivative circuit representation comprises a derivative characteristic matrix and the derivative source vector;
calculating a derivative state vector based on the derivative characteristic matrix and the derivative source vector; and
calculating an admittance based on the derivative auxiliary current and the auxiliary voltage value.

9. The method of claim 8, wherein obtaining the primary state vector further comprises:
applying the auxiliary voltage adjustment value to the derivative circuit representation;
calculating an adjustment state vector based on the derivative circuit representation with the auxiliary voltage adjustment value applied; and
obtaining the primary state vector by adding the adjustment state vector to the modified state vector and by adding the auxiliary voltage adjustment value to the auxiliary voltage value.

10. A non-transitory computer readable medium (CRM) storing instructions for calculating voltage values in a power grid, the instructions comprising functionality for:
obtaining a primary circuit representation corresponding to the power grid and comprising:
a plurality of nodes separated by a plurality of impedances; and
an independent source connected to one node of the plurality of nodes;
identifying a high degree node from the plurality of nodes;
obtaining a modified circuit representation by connecting, in the primary circuit representation, an auxiliary voltage source having an auxiliary voltage value to the high degree node, wherein the modified circuit representation comprises a modified characteristic matrix and a modified source vector;
calculating a modified state vector based on the modified characteristic matrix and the modified source vector;
generating an admittance matrix based on the plurality of impedances and the auxiliary voltage;
obtaining an auxiliary voltage adjustment value using the admittance matrix;
obtaining a primary state vector, wherein obtaining the primary state vector comprises adjusting the modified state vector using the admittance matrix and the auxiliary voltage adjustment value; and
obtaining the voltage values from the primary state vector.

11. The non-transitory CRM of claim 10, the instructions further comprising functionality for:
calculating an auxiliary current of the auxiliary voltage source from the modified state vector, wherein the auxiliary voltage adjustment value is further based on the auxiliary current.

12. The non-transitory CRM of claim of claim 10, the instructions further comprising for:
calculating a derivative auxiliary current of the auxiliary voltage source from a derivative state vector, wherein the admittance matrix is further based on the derivative auxiliary current.

13. The non-transitory CRM of claim 10, wherein the instructions for calculating the modified state vector comprise functionality for:
obtaining a plurality of factored matrices by factoring the modified characteristic matrix; and
performing a forward substitution and a backward substitution on the plurality of factored matrices.

14. The non-transitory CRM of claim 12, wherein the instructions for generating the admittance matrix comprise functionality for:
obtaining a derivative circuit representation by turning off, in the modified circuit representation, the independent source, wherein the derivative circuit representation comprises a derivative characteristic matrix and the derivative source vector;
calculating a derivative state vector based on the derivative characteristic matrix and the derivative source vector; and
calculating an admittance based on the derivative auxiliary current and the auxiliary voltage value.

15. The non-transitory CRM of claim 14, wherein the instructions for obtaining the primary state vector further comprise functionality for:
applying the auxiliary voltage adjustment value to the derivative circuit representation;
calculating an adjustment state vector based on the derivative circuit representation with the auxiliary voltage adjustment value applied; and
obtaining the primary state vector by adding the adjustment state vector to the modified state vector and by adding the auxiliary voltage adjustment value to the auxiliary voltage value.

16. A system for calculating voltage values in a power grid, comprising:
a hardware processor;
a matrix generator executing on the hardware processor and configured to:
obtain a primary circuit representation corresponding to the power grid and comprising:
a plurality of nodes separated by a plurality of impedances; and
an independent source connected to one node of the plurality of nodes;
identify a high degree node from the plurality of nodes;
obtain a modified circuit representation by connecting, in the primary circuit representation, an auxiliary voltage source having an auxiliary voltage value to the high degree node, wherein the modified circuit representation comprises a modified characteristic matrix and a modified source vector;
a matrix solver executing on the hardware processor and configured to:
calculate a modified state vector based on the modified characteristic matrix and the modified source vector;
an admittance module executing on the hardware processor and configured to:
generate an admittance matrix based on the plurality of impedances and the auxiliary voltage;
obtain an auxiliary voltage adjustment value using the admittance matrix;
a voltage adjuster executing on the hardware processor and configured to:
obtain a primary state vector, wherein obtaining the voltage vector comprises adjusting the modified voltage vector using the admittance matrix and the auxiliary voltage adjustment value; and
obtain the voltage values from the primary voltage vector.

17. The system of claim 16, wherein the high degree node has a number of connections greater than a threshold, and wherein the modified characteristic matrix is a conductance matrix.

18. The system of claim 16, wherein the admittance module configured to:
calculate a derivative auxiliary current of the auxiliary voltage source from a derivative state vector, wherein the admittance matrix is further based on the derivative auxiliary current.

19. The system of claim 18, wherein the admittance module is further configured to:
obtain a derivative circuit representation by turning off, in the modified circuit representation, the independent source, wherein the derivative circuit representation comprises a derivative characteristic matrix and the derivative source vector;
calculate a derivative state vector based on the derivative characteristic matrix and the derivative source vector; and
calculate an admittance based on the derivative auxiliary current and the auxiliary voltage value.

20. The system of claim 19, wherein the voltage adjuster is further configured to:
applying the auxiliary voltage adjustment value to the derivative circuit representation;
calculating an adjustment state vector based on the derivative circuit representation with the auxiliary voltage adjustment value applied; and
obtaining the primary state vector by adding the adjustment state vector to the modified state vector and by adding the auxiliary voltage adjustment value to the auxiliary voltage value.
